(19) United States
(12) Patent Application Publication
(10) Pub. No.: US 2004/0131341 A1
(43) Pub. Date: Jul. 8, 2004

(54) Portable digital audio/video device

(76) Inventor: Wen Hung Lien, Tanzih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/724,177

(22) Filed: Dec. 1, 2003

(30) Foreign Application Priority Data
Dec. 2, 2002 (TW) 91219435

(51) Int. Cl. H04N 5/781

(52) U.S. Cl. 386/125; 386/126

(57) ABSTRACT

A portable digital audio/video device is provided to work with a computer device, or removed from the computer device and work as an independent audio/video playing device. The portable digital audio/video device includes a disk interface connector and a USB port connector for engaging the corresponding connectors on the access slot of the computer device. The portable digital audio/video device includes a data type identification circuit for identifying the data format stored on a compact audio/video disk, and at least a data processing circuit. Each data processing circuit is designed to process, decode and output audio/video signals of a specific format.

### BACKGROUND OF THE INVENTION

1. Field of the Invention

This invention relates to a digital audio/video device and, more particularly, to a portable digital audio/video device that can be plugged into an access slot or removed from the access slot of the computer.

2. Description of the Prior Art

Computer is widely used nowadays. It is used in industries, commerce, offices, schools and households. A computer may be equipped with an audio/video playing device to form a basic multimedia device. Thereby, users can use the basic multimedia device to play the audio or video signals. Furthermore, the installation of a multimedia device to a portable computer such as a computer device enables the portability of the multimedia device.

The major information recording media in use nowadays include the compact disk (CD) and video compact disk (VCD). Both of the recording media can store a large amount of audio/video information. With the large memory of the recording media, the multimedia device is broadly used in most application.

However, when using a multimedia device with CD or VCD as the major recording medium, because of the restriction of the CD or VCD player, the multimedia device and the computer is lack of the portability and convenience.

In operating the CD or VCD device, the audio or video signals can be played only if the interconnection and driving function between the computer and the CD or VCD player are normal. When the CD or VCD player plays, it occupies the resources of the computer system. Therefore, the other application running on the computer cannot operate at its optimized performance. Even worse, the audio/video device cannot be used when it is disconnected from the computer equipment, or when the computer equipment is turned-off or malfunctions.

The widely used MP3 audio playing device (the playing device with the third generation audio/video compression format), because of its large storage capacity, low unit-access cost, and convenience of use, has been become an important multimedia device. Currently, MP3 audio player is mostly used as a portable music device, while manufacturers are actively seeking new applications. For example, Taiwan Patent No. 477,504 disclosed an MP3 player that can be used with mobile phone. The MP3 device comprises an automatic switching circuit connected to the mobile phone and a switch. The automatic switch circuit controls the switch, based on whether the mobile is receiving an incoming signal. When the mobile is standby, the automatic switch circuit switches the switch to “OPEN”, so that the compressed voice signal can be decompressed and played through a speaker. On the other hand, when the mobile phone detects an incoming signal, the automatic switch circuit switches the switch to “CLOSE” to pause the playing, so that the user can receive the incoming call. As this prior patent is designed to integrate an MP3 player with a mobile phone, it is only applicable to the mobile phones.

As for integrating an MP3 audio player with a computer device, Taiwan Patent No. 467,345 disclosed a portable hard disk device for storing and playing digital music. The portable hard disc device stores the digital music data (such as MP3) and includes a digital decoder. With the digital decoder, the stored music data can be decoded and played. The invention simply uses the portable hard disk device as an MP3 player, but not for other applications. Its application is limited in terms of commerce.

### SUMMARY OF THE INVENTION

To solve the aforementioned problems, the primary object of the present invention is to provide a multi-function digital audio/video device, which is able to perform the functions of an MP3 playing device, a musical CD playing device, and an audio/video CD playing device, so that when a computer device is equipped the digital audio/video device, the computer processes an improved multimedia capability.

Another object of the present invention is to provide a portable digital audio/video device, which not only works with a computer for playing of audio/video signals, but also works independently as an audio/video playing device when it is not connected to the computer. The capability of stand-alone operation alleviates the restriction of the aforementioned problem.

A further object of the present invention is to provide a portable digital audio/video recording device, which not only works with a computer device as an audio/video multimedia device, but also works as a plug-and-play or extended information recording media.

A still further object of the present invention is to provide a portable digital audio/video device, which does not occupy much of the system resources of a computer device when it works with the computer device as a multimedia playing device. Because the portable digital audio/video device has the capability to process multimedia data, it can save the system resources of the computer when playing the multimedia data. Therefore, the computer device can improve its performance when playing the multimedia applications.

The technique used in the present invention is to install an access slot with connectors at the appropriate location on the computer device. The portable digital audio/video device can be plugged into or removed from the access slot. The portable digital audio/video device comprises a control circuit for determining the type of the disk placed in the disk supporting plate and activating the circuit for playing the audio/video based on the type of the disk. When the portable digital audio/video device is in the access slot, the computer device can access and play the audio/video data stored in the portable digital audio/video device through the interface circuit on the audio/video device. On the other hand, when the portable digital audio/video device is removed from the access slot, the portable digital audio/video device can independently play the audio/video data. Preferably, the control circuit of the portable digital audio/video device comprises at least an MP3, CD, VCD data processing circuit for processing MP3 audio signal, CD audio signal, or VCD audio/video signal.

With the techniques employed in the present invention, the functions of the MP3 playing device, CD playing device, and VCD playing device are incorporated into a multi-functional digital audio/video device that can be connected to and improve the multimedia capability of a computer device. The portable digital audio/video device not only can be connected to a computer device to play audio and video, but also can work independently to play audio/video. The portable digital audio/video device does not occupy much of the system resources of a computer device when it works with the computer device as a multimedia playing device. Because the portable digital audio/video device has the capability to process multimedia data, it can relieve the computer device from using system resources when playing the multimedia data. Therefore, the computer device can improve its performance when playing the multimedia applications.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 is a perspective view showing a portable digital audio/video device in accordance with a preferred embodiment of the present invention is removable from a slot of a computer device;

FIG. 2 is a front perspective view of the portable digital audio/video device of the present invention;

FIG. 3 is a rear perspective view of the portable digital audio/video device of the present invention;

FIG. 4 shows a schematic view when a CD is placed in the disk supporting plate of the portable digital audio/video device;

FIG. 5 shows a partial sectional view of the slot of the computer device shown in FIG. 1;

FIG. 6 shows a functional block diagram of a circuit connecting the portable digital audio/video device and the computer device; and

FIG. 7 shows a block diagram of a control circuit of the portable digital audio/video device in more detail of the present invention.

### DETAILED DESCRIPTION OF THE INVENTION

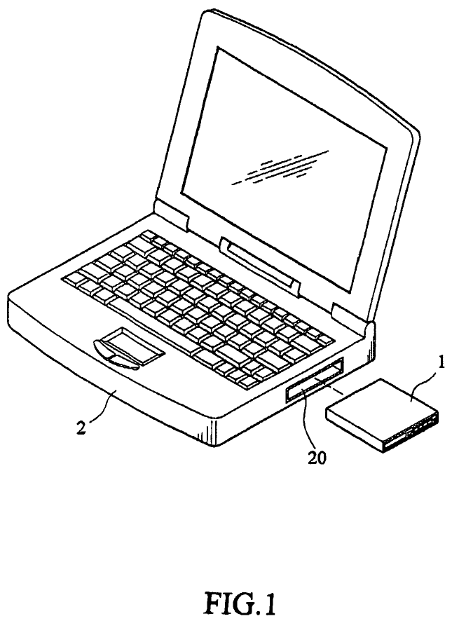

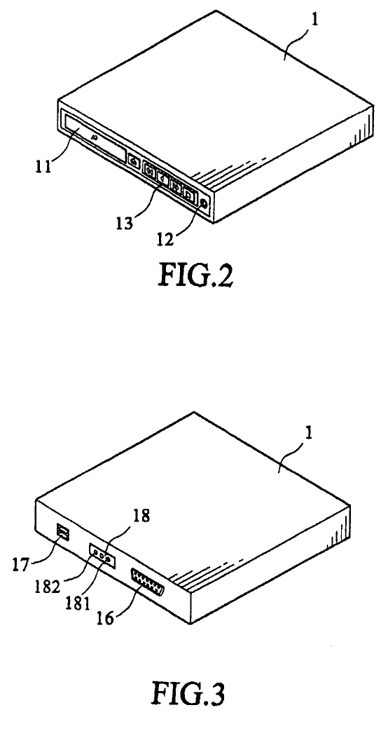

FIG. 1 is a perspective view showing a portable digital audio/video device 1 in accordance with a preferred embodiment of the present invention is removable from a slot 20 of a computer device 2. In the preferred embodiment shown in FIG. 1, the computer device 2 is a portable computer. FIG. 2 is a front perspective view of the portable digital audio/video device 1 of the present invention, and FIG. 3 is a rear perspective view of the portable digital audio/video device 1 of the present invention.

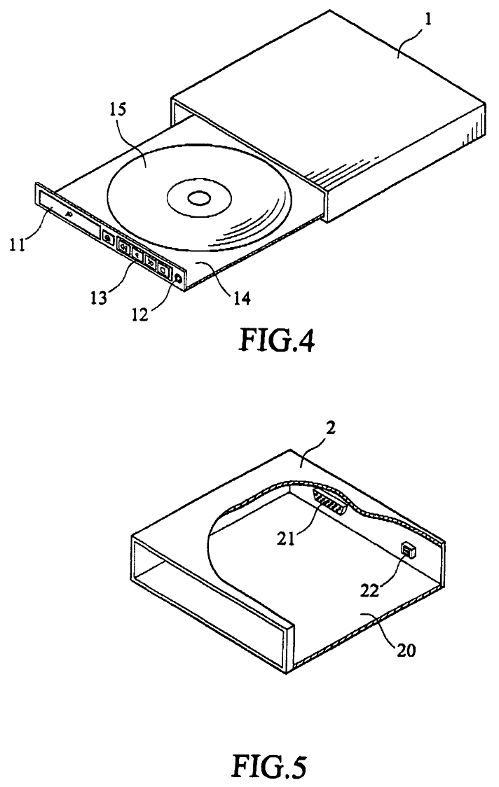

As shown in the figures, the front panel of the portable digital audio/video device 1 of the present invention comprises a display unit 11 e.g. liquid crystal display (LCD) or light emitting diode (LED) display, an earphone slot 12, and a control button set 13 comprising a plurality of control buttons for e.g. play, forward, rearward, pause, eject, and so on. As shown in FIG. 4, the portable digital audio/video device 1 comprises a disk supporting plate 14 which may be retained in the inner space of the portable digital audio/video device 1 and ejected from the inner space of the portable digital audio/video device 1. When the disk supporting plate 14, together with the front panel, is ejected from the inner space of the portable digital audio/video device 1, a compact disk 15 can be placed thereon or removed from the disk supporting plate 14. The compact disk 15 may be an audio disk or a video disk.

As shown in FIG. 3, the back panel of the portable digital audio/video device 1 comprises a disk interface connector 16 (e.g. standard IDE interface), a standard USB port connector 17, and an analog audio/video output signal connector 18 which further comprises an audio signal socket 181 and a video signal socket 182.

Please refer to FIG. 5 which shows a partial sectional view of the slot 20 of the computer device 2 shown in FIG. 1. The access slot 20 is mounted at an appropriate location on the computer device 2. The access slot 20 comprises a disk interface connector 21 and a USB port connector 22 arranged on a rear side wall inside the access slot 20. When the portable digital audio/video device 1 is plugged into the access slot 20, the disk interface connector 21 and the USB port connector 22 of the access slot 20 are plugged into the corresponding disk interface connector 16 and the USB port connector 17 on the back panel of the portable digital audio/video device 1, respectively.

When the portable digital audio/video device 1 of the present invention is removed from the access slot 20 of the computer device 2, the user can use the functions provided by the portable digital audio/video device 1, such as MP3, CD, and VCD playing, as a regular audio/video playing device. For example, the user can plug an earphone into the earphone slot 12 to listen to the CD or MP3 audio output from the portable digital audio/video device 1. Alternatively, the user can use an external speaker and an external display, plugged into the audio signal socket 181 and the video signal socket 182, respectively, to watch the video.

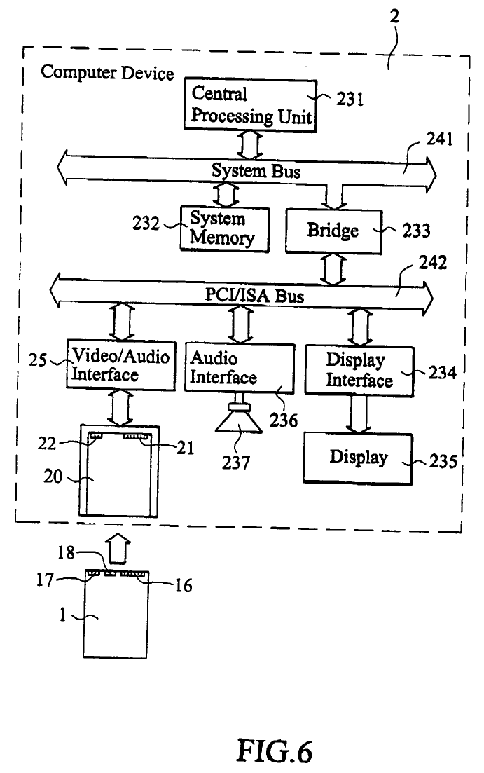

FIG. 6 shows a functional block diagram of a circuit connecting the portable digital audio/video device and the computer device. A typical computer device 2 mainly comprises a central processing unit (CPU) 231, a main memory 232, a bridge 233, a display interface 234, a display 235, an audio interface 236, and an audio device 237. The CPU 231 and the main memory 232 are both connected to a system bus 241 of the computer device 2. The system bus 241 is connected through bridge 233 to a PCI/ISA bus 242. The display interface 234 and the audio interface 236 are both connected to the PCI/ISA bus 242 of the computer device 2. The display 235 can display the video signal generated by the computer device 2 through the display interface 234. The audio device 237 can play the audio signal generated by the computer device 2 through the audio interface 236.

In addition, the PCI/ISA bus 242 of the computer device 2 is connected to an audio/video interface 25 which is connected to the disk interface connector 21 and the USB port connector 22 of the access slot 20. When the portable digital audio/video device 1 is plugged into the access slot 20, the disk interface connector 21 and the USB port connector 22 are plugged, respectively, into the disk interface connector 16 and the USB port connector 17 on the back panel of the portable digital audio/video device 1.

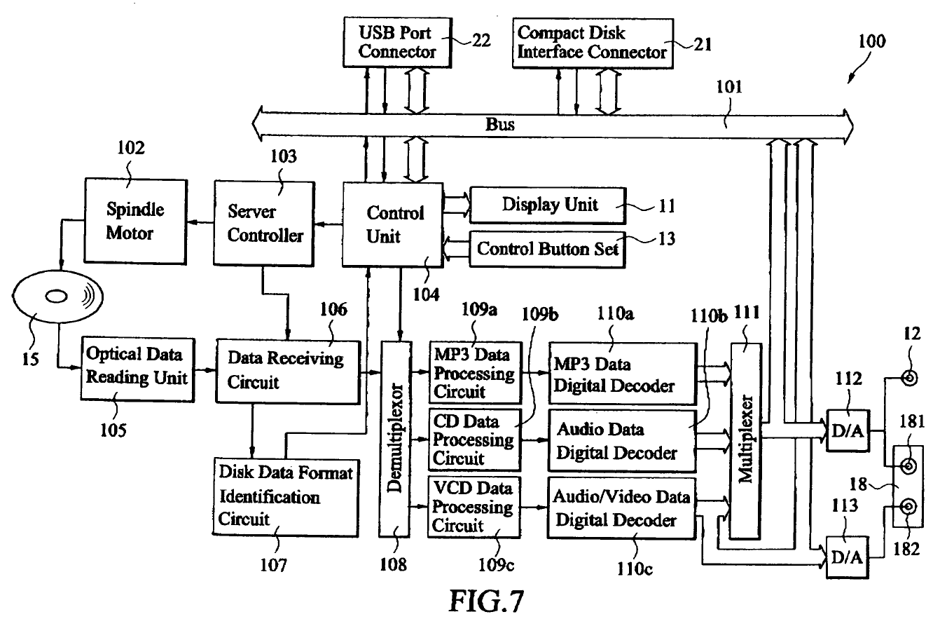

FIG. 7 shows a block diagram of a control circuit of the portable digital audio/video device in more detail of the present invention. In the control circuit 100 of the portable digital audio/video device 1, a compact disk 15 placed in the disk supporting plate 14 of the portable digital audio/video device 1 can be rotated by a spindle motor 102, and controlled by a server controller 103 and a control unit 104. The data stored on the compact disk 15 may be read by an optical data reading unit 105, and then the read data may be received by a data receiving circuit 106.

A disk data format identification circuit 107 can be used to identify the data format stored on the compact disk 15, such as MP3, CD, or VCD. After the identification of data format, a demultiplexor 108, controlled by the control unit 104, is used to select a proper data path for transmitting the received data. Namely, the demultiplexor is provided with an input port connected to the data receiving circuit 106 and a plurality of output data paths, for selecting one of the data paths based on the identified data format of the read data.

If the data format on the compact disk 15 is MP3, the data is sent to a MP3 data processing circuit 109a for MP3 data processing, and then to an MP3 data digital decoder 110a for MP3 data decoding. If the data format on the compact disk 15 is audio data, the data is sent to an audio data processing circuit 109b for audio data processing, and then to an audio data digital decoder 110b for audio data decoding. If the data format on the compact disk 15 is audio/video signal, the data is sent to an audio/video data processing circuit 109c for audio/video data processing, and then to an audio/video data digital decoder 110c for audio/video data decoding.

A multiplexor 111 has a plurality of input data paths connected to the MP3 data digital decoder 110a, the audio data digital decoder 110b, and the audio/video data digital decoder 110c respectively and an output port. The multiplexor 111 can receive the processed and decoded audio/video data from one of the MP3 data digital decoder 110a, the audio data digital decoder 110b, or the audio/video data digital decoder 110c and transmitting the processed and decoded audio/video data at its output port.

The decoded MP3, audio, or audio/video signals are transmitted through the multiplexer 111 to a digital-to-analog (D/A) converter 112 to convert the digital data to analog signals. In case of audio/video disk, the digital audio/video data decoded by aforementioned audio/video data digital decoder 110c are also transmitted through a digital-to-analog (D/A) converter 113 to convert the digital video data to analog video signals.

The audio signal from the previous processing circuit can be sent to the earphone slot 12 and the audio signal socket 181 of the audio/video output signal connector 18 simultaneously. The video signal is sent to the video signal socket 182 of the audio/video output signal connector 18.

The portable digital audio/video device 1 of the present invention also comprises a bus 101, to which the data lines, address lines, and control lines of the control unit 104 are connected. The obtained MP3, audio, or audio/video digital data are also connected to the bus 101. The signal pins of the bus 101 are appropriately arranged so that the portable digital audio/video device 1 can be connected to the computer device 2 through the disk interface connector 21 and USB port connector 22.

When the portable digital audio/video device 1 is plugged into the access slot 20 of the computer device 2, it is connected to the PCI/ISA bus 242 of the computer device 2 through the audio/video interface 25. Therefore, the audio/video signal generated by the portable digital audio/video device 1 can be played on the display 235 and the audio device 237 of the computer device 2, as a multimedia device. Because the stored audio/video data on the compact disk is processed by the control circuit of the portable digital audio/video device 1, the computer device does not use much system resource on data processing when playing audio/video signals.

Furthermore, when the portable digital audio/video device 1 is plugged into the computer device 2, it can also work as plug-and-play or extended information recording medium in addition to its multimedia functionality. For example, the text, audio, or video data can be loaded into the portable digital audio/video device 1 for the computer device to access.

On the other hand, when the portable digital audio/video device 1 of the present invention is removed from the access slot 20 of the computer device 2, it can operate independently. Because the control circuit of the portable digital audio/video device 1 is capable of independent data processing, the display of video or play of audio can be accomplished with a built-in or external earphone, speaker, and display. The portable digital audio/video device 1 can be used as a portable audio/video playing device. In conclusion, the portable digital audio/video device disclosed in the present invention is highly applicable in commerce use.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A portable digital audio/video device adapted to be plugged into an access slot form on a computer device and removable from the access slot, comprising:
a casing having an inner space;
a disk supporting plate for supporting a compact disk thereon and retractable into the inner space of the casing, the compact disk having data with specific data format;
an operation panel with a display unit and a button set, formed on a front end of the casing;
a control circuit, for identifying the data format of the data stored in the compact disk and activating, based on identified data format, a corresponding audio/video data processing circuit to generate an audio/video signal in correspondence to the data stored in the compact disk; and
means for connecting the portable digital audio/video device and the computer device, and transmitting the audio/video signal from the portable digital audio/video device to the computer device;
wherein the computer device accesses and plays the signal generated by the control circuit when the portable digital audio/video device is connected the computer device, and the portable digital audio/video device plays the audio/video signal independently when the portable digital audio/video device is removed from the access slot of the computer device.

2. The portable digital audio/video device as claimed in claim 1, wherein the control circuit comprises:
means for reading the data stored in the disk;
a disk data format identification circuit, for identifying the read data format of the data stored in the disk;
a demultiplexor having an input port connected to the data reading means and a plurality of output data paths, for selecting one of the data paths based on the identified data format of the read data;
a plurality of audio/video data processing circuits connected to the output data paths of the demultiplexor respectively for processing and decoding the read data transmitted from the demultiplexor;
a multiplexor having a plurality of input data paths connected to the audio/video data processing circuits respectively and an output port, for receiving the processed audio/video data from one of the data processing circuits and transmitting the processed audio/video data at its output port; and
means for converting the audio/video data transmitted from the output port of the multiplexor into an analog audio/video signals.

3. The portable digital audio/video device as claimed in claim 2, wherein the audio/video data processing circuits at least comprises an MP3 data processing circuit, an audio data processing circuit, an audio/video data processing circuit.

4. The portable digital audio/video device as claimed in claim 1, wherein the casing of the device is equipped with an earphone slot.

5. The portable digital audio/video device as claimed in claim 1, wherein the connecting means comprises:
a first disk interface connector, installed in the casing and connected to the control circuit; and
a second disk interface connector, installed inside the access slot of the computer device, and connected to the first disk interface connector of the casing.

6. The portable digital audio/video device as claimed in claim 1, wherein the connecting means comprises:
a first USB port connector, installed inside the casing and connected to the control circuit; and
a second USB port connector, installed inside the access slot of the computer device and connected to the first USB port connector of the casing.

7. The portable digital audio/video device as claimed in claim 1, further comprising an analog audio/video signal output connector, installed in the casing, and connected to the control circuit, the analog audio/video signal output connector further comprising an audio signal socket and a video output slot for outputting the analog audio/video signals.
